(19) United States
(12) Patent Application Publication
(10) Pub. No.: US 2026/0094582 A1
(43) Pub. Date: Apr. 2, 2026

(54) Guitar Fingerboard Comfort and Positioning Support Pad

(71) Applicant: Gary Thompkins, Detroit, MI (US)

(72) Inventor: Gary Thompkins, Detroit, MI (US)

(21) Appl. No.: 18/904,762

(22) Filed: Oct. 2, 2024

(51) Int. Cl. G10D 3/18

(52) U.S. Cl. CPC G10D 3/18

(57) ABSTRACT

A guitar positioning arrangement includes a guitar pad and a connecting arrangement. The guitar pad is in the form of a wedge that tapers in thickness from the bottom surface portion to the upper surface portion. The guitar pad includes a support surface positioned opposite and at an angle to the engagement surface and designed to rest against the body of a user playing a guitar. This angled design positions the guitar at an angle with respect to the body of the user to permit improved viewing of the frets and strings of the guitar.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to guitar accessories and more particularly pertains to a new guitar fingerboard comfort and positioning support pad for tilting the guitar to make it easier to see the frets and strings. When playing a guitar, it is common to for the user to tilt the guitar to better allow the user to see the guitar fret, neck, and strings. This twisting or tilting can be challenging to do and uncomfortable for the user.

### (2) Description of Related Art Including Information Disclosed Under 37 CFR 1.97 and 1.98

The prior art relates to guitar accessories, such as support brackets and braces attachable to the edges of a guitar body for placement on the thighs or lap of seated guitar players. The prior art, as best understood, does not disclose a guitar pad with an adjustable strap and removable attachment devices, such as suction cups.

### BRIEF SUMMARY OF THE INVENTION

An embodiment of the disclosure meets the needs presented above in a guitar fingerboard comfort and positioning support pad, also referred to herein as a guitar positioning arrangement, includes a guitar pad and a connecting arrangement. The guitar pad includes an engagement surface that is designed to be placed facing the rear surface of a guitar body. The connecting arrangement is positioned at the engagement surface and designed to removably attach the guitar pad to the rear surface of a guitar body. The guitar pad has a height that is approximately equivalent to half the width of a guitar body. The guitar pad includes a bottom surface portion designed to be positioned adjacent a central portion of the rear surface of a guitar body. The guitar pad includes an upper surface portion designed to be positioned adjacent an upper perimeter portion of the rear surface of a guitar body. The bottom surface portion is thicker than the upper surface portion such that the guitar pad is in the form of a wedge that tapers in thickness from the bottom surface portion to the upper surface portion. The guitar pad includes a support surface positioned opposite and at an angle to the engagement surface and designed to rest against the body of a user playing a guitar. This angled design positions the guitar at an angle with respect to the body of the user such that a lower portion of the guitar is positioned further from body of the user than an upper portion of the guitar to permit improved viewing of the frets and strings of the guitar.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a guitar positioning arrangement according to an embodiment of the disclosure.

FIG. 2 is a rear perspective view of an embodiment of the disclosure.

FIG. 3 is a side perspective view of an embodiment of the disclosure.

FIG. 4 is a cross-sectional view of an embodiment of the disclosure.

FIG. 5 is a rear perspective view of an embodiment of the disclosure.

FIG. 6 is a front perspective view of an embodiment of the disclosure.

FIG. 7 is a rear perspective view of an embodiment of the disclosure.

FIG. 8 is a rear perspective view of an embodiment of the disclosure.

FIG. 9 is a side view of an embodiment of the disclosure.

FIG. 10 is a side perspective view of an embodiment of the disclosure.

### DETAILED DESCRIPTION OF THE INVENTION

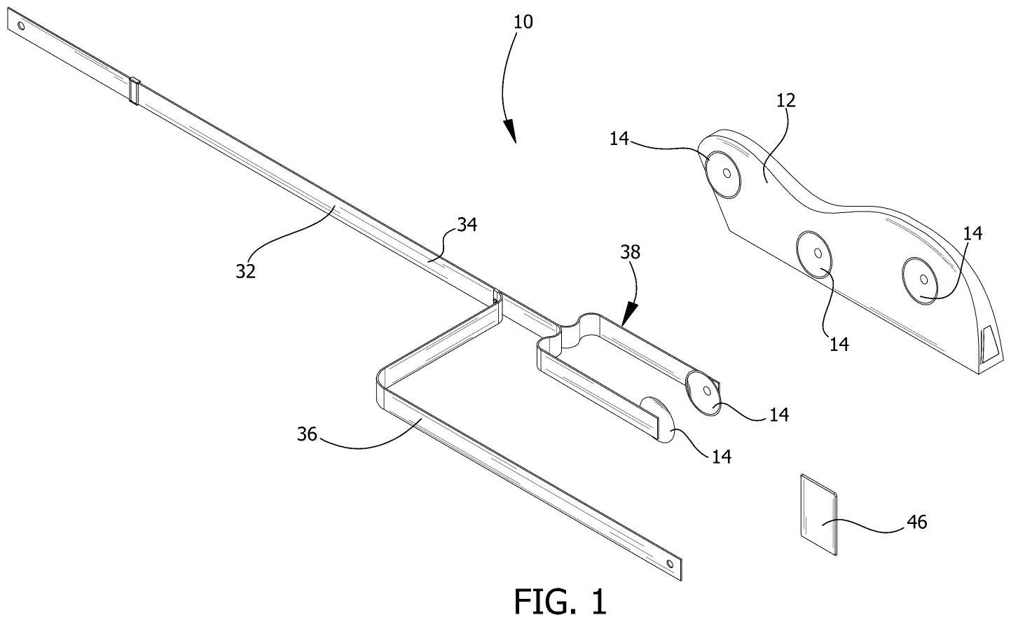

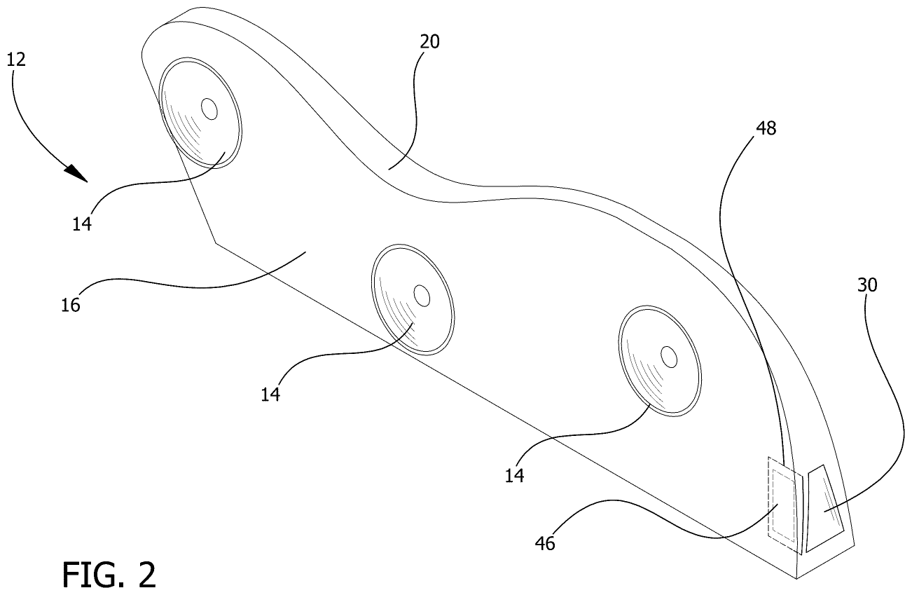

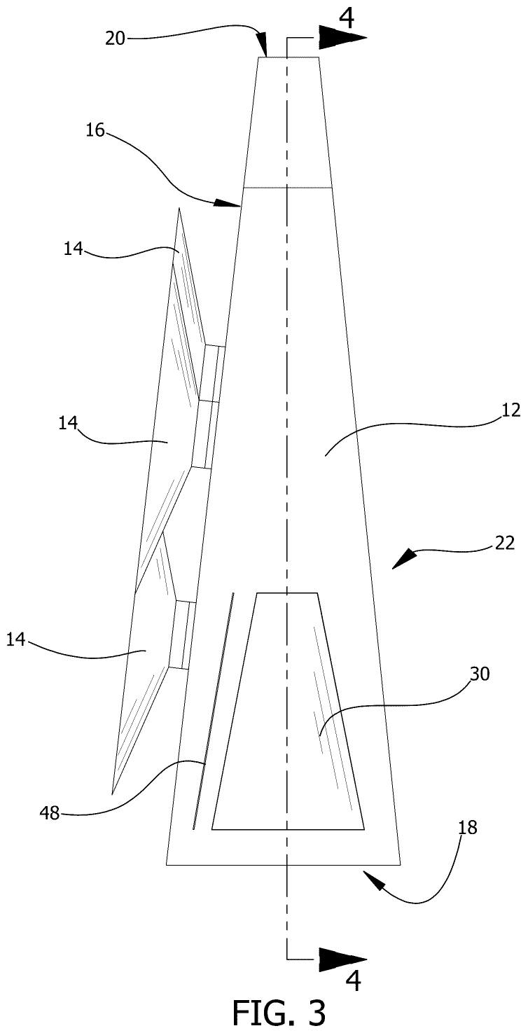

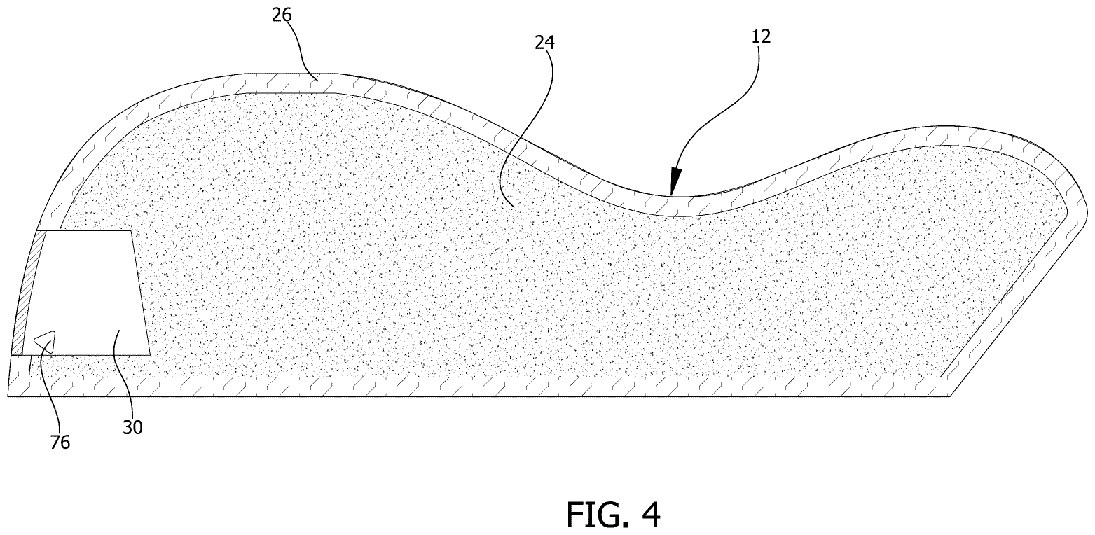

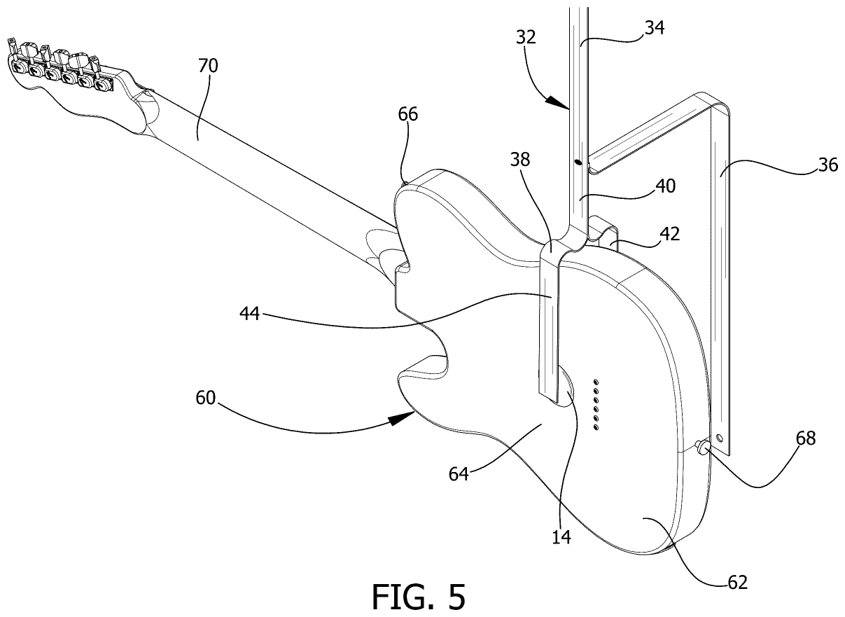

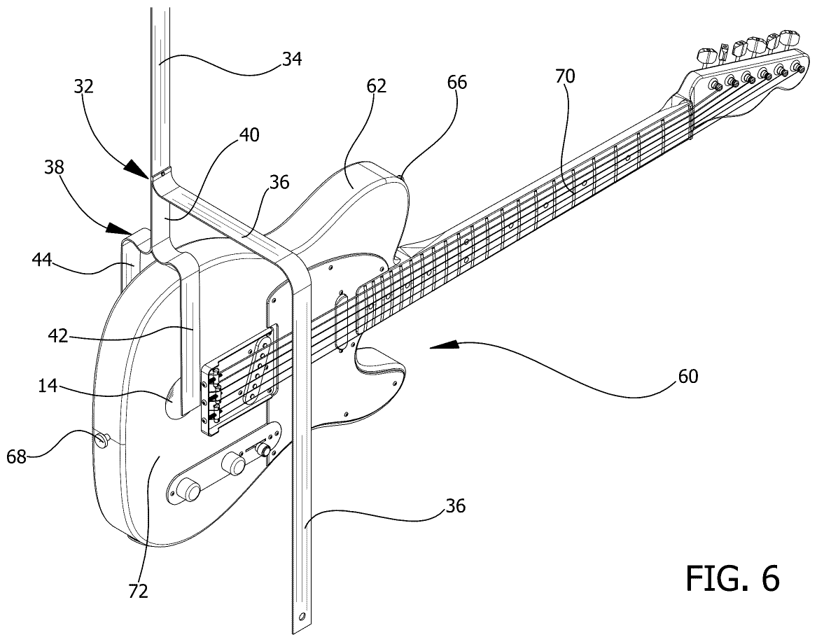

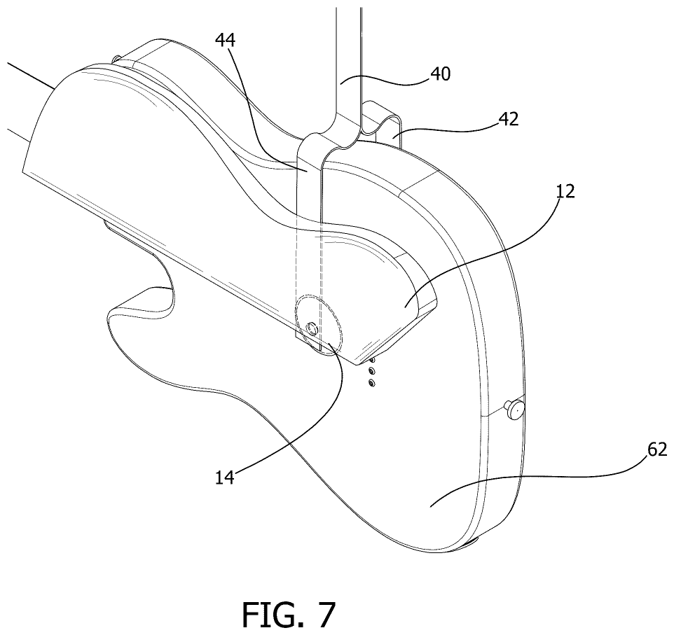

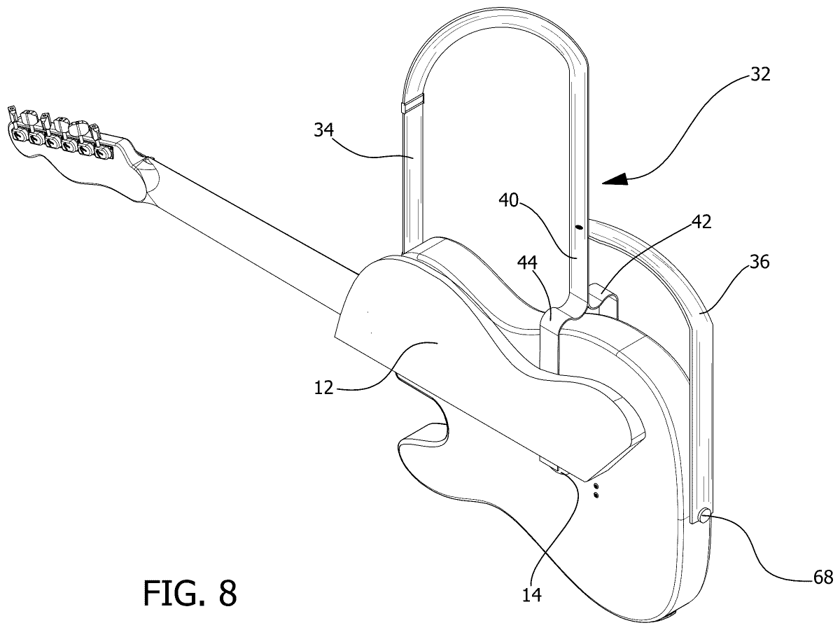

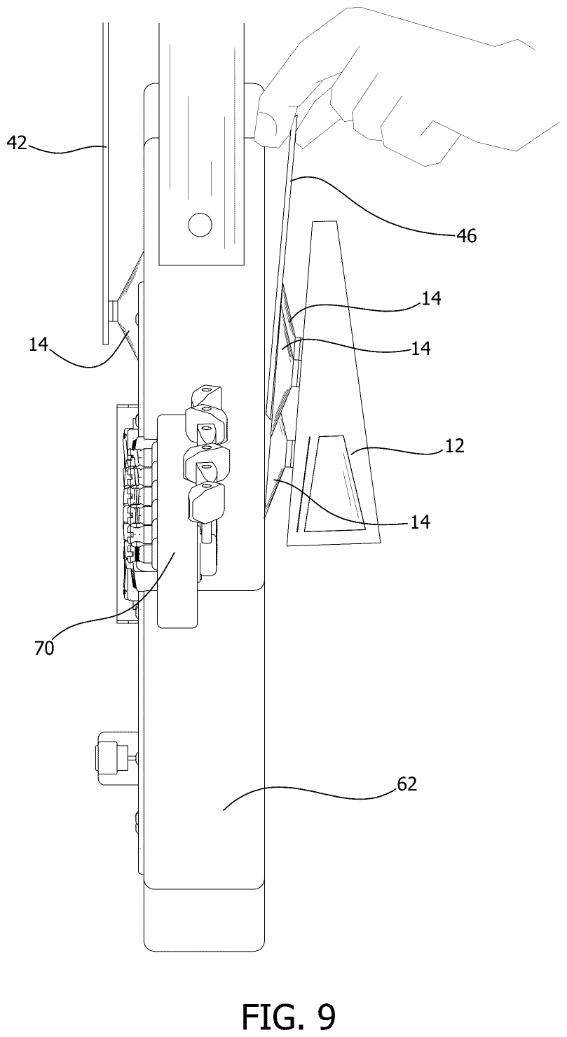

With reference now to the drawings, and in particular to FIGS. 1 through 10 thereof, a new guitar positioning arrangement embodying the principles and concepts of an embodiment of the disclosure and generally designated by the reference numeral 10 will be described.

As best illustrated in FIGS. 1 through 10, the guitar positioning arrangement 10 generally comprises A guitar positioning arrangement 10 includes a guitar pad 12 and a connecting arrangement, which in the embodiment shown comprises suction cups 14. The guitar positioning arrangement 10 is used in conjunction with a guitar 60. The guitar pad 12 includes an engagement surface 16 that is designed to be placed facing the rear surface 64 of a guitar body 62. The connecting arrangement is positioned at the engagement surface 16 and designed to removably attach the guitar pad 12 to the rear surface 64 of a guitar body 62. The guitar pad 12 has a height that is approximately equivalent to half the width of a guitar body 62. The guitar pad 12 includes a bottom surface portion 18 designed to be positioned adjacent a central portion of the rear surface 64 of a guitar body 62. The guitar pad 12 includes an upper surface portion 20 designed to be positioned adjacent an upper perimeter portion of the rear surface 64 of a guitar body 62. The bottom surface portion 18 is thicker than the upper surface portion 20 such that the guitar pad 12 is in the form of a wedge that tapers in thickness from the bottom surface portion 18 to the upper surface portion 20. The guitar pad 12 includes a support surface 22 positioned opposite and at an angle to the engagement surface 16 and designed to rest against the body of a user playing a guitar 60. This angled design positions the guitar 60 at an angle with respect to the body of the user such that a lower portion of the guitar 60 is positioned further from body of the user than an upper portion of the guitar 60 to permit improved viewing of the frets and strings of the guitar 60.

In accordance with at least one possible embodiment, the upper surface portion 20 includes a curved or s-shaped perimeter edge designed to essentially match or follow the contour of an upper perimeter portion of the rear surface 64 of a guitar body 62.

In accordance with at least one possible embodiment, the guitar pad 12 includes a foam material 24 and a cover 26 made of fabric, such as cloth or denim, or a plastic.

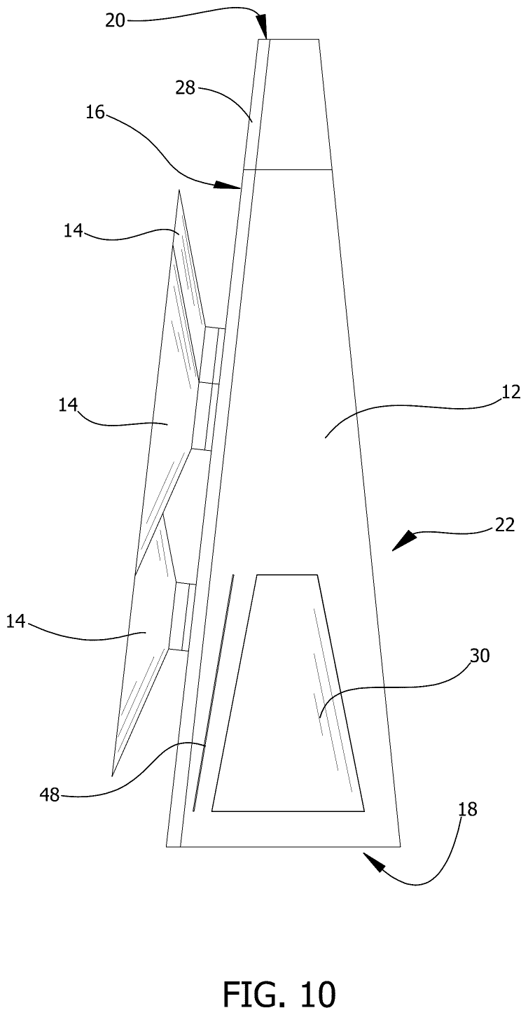

In accordance with at least one possible embodiment, the guitar pad 12 includes a rigid plastic backing layer 28 positioned at the engagement surface 16, as shown for example in FIG. 10.

In accordance with at least one possible embodiment, the guitar pad 12 includes a compartment 30 designed to store guitar picks 76 or other small musician accessories.

In accordance with at least one possible embodiment, the guitar positioning arrangement 10 further includes a guitar strap 32, wherein the guitar strap 32 includes an adjustable shoulder portion 34, a rear portion 36, and a stabilizing portion 38. The adjustable shoulder portion 34 is designed to attach to a front strap connector 66 on a guitar body 62 adjacent a guitar neck 70. The rear portion 36 is designed to attach to a rear strap connector 68 on a guitar body 62 at a rear end of the guitar body 62. The stabilizing portion 38 is positioned at the intersection of the adjustable shoulder portion 34 and the rear portion 36. The stabilizing portion 38 is substantially y-shaped and includes a main strap portion 40, a first branch strap portion 42, and a second branch strap portion 44. The first branch strap portion 42 is designed to removably attach to a central section of the front surface 72 of the guitar body 62 and the second branch strap portion 44 is designed to removably attach to a central section of the rear surface 64 of the guitar body 62 to further stabilize the guitar body 62 upon use thereof by a user.

In accordance with at least one possible embodiment, the first branch strap portion 42 includes a first suction cup 14 and the second branch strap portion 44 includes a second suction cup 14.

In accordance with at least one possible embodiment, the second branch strap portion 44 is designed to be positioned between the guitar pad 12 and the rear surface 64 of a guitar body 62.

In accordance with at least one possible embodiment, the guitar positioning arrangement 10 further includes a removal card 46 designed to be used by a user to slide under and break the suction seal between any one of the suction cups 14.

In accordance with at least one possible embodiment, the guitar pad 12 includes a storage pocket 48 designed to store the removal card 46.

In one possible embodiment, the pad 12 could be made of a foam rubber material and measure about 13 to 18 inches long, about 6 to 7 inches wide, and about 3 to 4 inches thick, including any whole numbers or tenths therein. The pad 12 could be shaped or contoured to resemble portions of the guitar body 62. The pad 12 could be covered in a denim material or other natural or synthetic material that is durable and/or aesthetically pleasing.

In use, the user attaches the guitar pad 12 to the guitar 60, which allows the user, when playing the guitar 60, to rest the guitar pad 12 against the user's body. Due to the wedge shape of the guitar pad 12, the guitar 60 is angled generally upwardly so the user can better see the front of the guitar 60 to make playing easier without the strain on the hands or arms needed when holding and tilting the guitar 60. The guitar strap 32 provides additional support and stabilization.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A guitar positioning arrangement comprising:
a guitar pad comprising an engagement surface being configured to be placed facing the rear surface of a guitar body;
a connecting arrangement being disposed at said engagement surface and configured to removably attach said guitar pad to the rear surface of a guitar body;
said guitar pad having a height approximately equivalent to half the width of a guitar body;
said guitar pad comprising a bottom surface portion configured to be disposed adjacent a central portion of the rear surface of a guitar body;
said guitar pad comprising an upper surface portion configured to be disposed adjacent an upper perimeter portion of the rear surface of a guitar body;
said bottom surface portion being thicker than said upper surface portion such that said guitar pad being in the form of a wedge that tapers in thickness from said bottom surface portion to said upper surface portion; and
said guitar pad comprising a support surface disposed opposite and at an angle to said engagement surface and configured to rest against the body of a user playing a guitar and thereby position the guitar at an angle with respect to the body of the user such that a lower portion of the guitar is positioned further from body of the user than an upper portion of the guitar to permit improved viewing of the frets and strings of the guitar.

2. The guitar positioning arrangement of claim 1, wherein said upper surface portion comprises a curved or s-shaped perimeter edge configured to essentially match or follow the contour of an upper perimeter portion of the rear surface of a guitar body.

3. The guitar positioning arrangement of claim 2, wherein said connecting arrangement comprises at least two suction cups disposed to project from said engagement surface.

4. The guitar positioning arrangement of claim 3, wherein said guitar pad comprises a foam material and a cover comprising fabric or plastic.

5. The guitar positioning arrangement of claim 4, wherein said guitar pad comprises a rigid plastic backing layer disposed at said engagement surface.

6. The guitar positioning arrangement of claim 5, wherein said guitar pad comprises a compartment configured to store guitar picks or other small musician accessories.

7. The guitar positioning arrangement of claim 6, further comprising a guitar strap, wherein said guitar strap comprises:
an adjustable shoulder portion configured to attach to a front strap connector on a guitar body adjacent a guitar neck;
a rear portion configured to attach to a rear strap connector on a guitar body at a rear end of the guitar body;
a stabilizing portion disposed at the intersection of said adjustable shoulder portion and said rear portion;
said stabilizing portion is substantially y-shaped and comprises a main strap portion, a first branch strap portion, and a second branch strap portion; and
said first branch strap portion is configured to removably attach to a central section of the front surface of a guitar body and said second branch strap portion is configured to removably attach to a central section of the rear surface of the guitar body to further stabilize the guitar body upon use thereof by a user.

8. The guitar positioning arrangement of claim 7, wherein said first branch strap portion comprises a first suction cup and said second branch strap portion comprises a second suction cup.

9. The guitar positioning arrangement of claim 8, wherein said second branch strap portion is configured to be positioned between said guitar pad and the rear surface of a guitar body.

10. The guitar positioning arrangement of claim 9, further comprising a removal card configured to be used by a user to slide under and break the suction seal between any one of said suction cups.

11. The guitar positioning arrangement of claim 10, wherein said guitar pad comprises a storage pocket configured to store said removal card.

12. The guitar positioning arrangement of claim 1, wherein said connecting arrangement comprises at least two suction cups disposed to project from said engagement surface.

13. The guitar positioning arrangement of claim 1, wherein said guitar pad comprises a foam material and a cover comprising fabric or plastic.

14. The guitar positioning arrangement of claim 1, wherein said guitar pad comprises a rigid plastic backing layer disposed at said engagement surface.

15. The guitar positioning arrangement of claim 1, wherein said guitar pad comprises a compartment configured to store guitar picks or other small musician accessories.

16. The guitar positioning arrangement of claim 1, further comprising a guitar strap, wherein said guitar strap comprises:
an adjustable shoulder portion configured to attach to a front strap connector on a guitar body adjacent a guitar neck;
a rear portion configured to attach to a rear strap connector on a guitar body at a rear end of the guitar body;
a stabilizing portion disposed at the intersection of said adjustable shoulder portion and said rear portion;
said stabilizing portion is substantially y-shaped and comprises a main strap portion, a first branch strap portion, and a second branch strap portion; and
said first branch strap portion is configured to removably attach to a central section of the front surface of a guitar body and said second branch strap portion is configured to removably attach to a central section of the rear surface of the guitar body to further stabilize the guitar body upon use thereof by a user.

17. The guitar positioning arrangement of claim 16, wherein said first branch strap portion comprises a first suction cup and said second branch strap portion comprises a second suction cup.

18. The guitar positioning arrangement of claim 17, wherein said second branch strap portion is configured to be positioned between said guitar pad and the rear surface of a guitar body.

19. The guitar positioning arrangement of claim 1, further comprising a removal card configured to be used by a user to slide under and break the suction seal between any one of said suction cups.

20. The guitar positioning arrangement of claim 19, wherein said guitar pad comprises a storage pocket configured to store said removal card.
